(19) United States
(12) Patent Application Publication
(10) Pub. No.: US 2025/0050246 A1
(43) Pub. Date: Feb. 13, 2025

(54) A FILTER MEDIUM CONTAMINATION DETECTION STRUCTURE, A FILTER DEVICE, AND A FILTER WITH ABNORMAL WARNING FUNCTION

(71) Applicant: Intex Marketing Ltd., Tortola (VG)

(72) Inventors: Zhi Xiong Huang, Fujian (CN); Ying Biao Zhang, Fujian (CN); Zheng Wen Lin, Fujian (CN)

(73) Assignee: Intex Marketing Ltd., Tortola (VG)

(21) Appl. No.: 18/723,630

(22) PCT Filed: Dec. 23, 2022
(86) PCT No.: PCT/IB2022/062753

§ 371 Date: Jun. 24, 2024

(30) Foreign Application Priority Data
Dec. 24, 2021 (CN) 202123295678.1
Jan. 14, 2022 (CN) 202220102253.X

(51) Int. Cl. B01D 27/10; B01D 29/60; B01D 35/143

(52) U.S. Cl. CPC B01D 27/101; B01D 29/606; B01D 35/1435; B01D 2201/29

(57) ABSTRACT

A filter medium contamination detection structure may comprise a filter element and a prompt assembly. The prompt assembly may comprise a first pressure sensor, which may comprise a signal output end, and a second pressure sensor, which may comprise a signal output end. The first pressure sensor may be connected to a water inlet of the filter element, and the second pressure sensor may be connected to a water outlet of the filter element or outside air. The signal output ends of the first pressure sensor and the second pressure sensor may be connected to a signal input end of a controller. When the filter element is dirty, a pressure at the water inlet end may increase or a pressure at the water outlet end may decrease, and the difference between the first sensor and the second pressure sensor may increase.

### RELATED APPLICATIONS

This application is related to Chinese patent application number 20212395678.1, filed on Dec. 24, 2021; and Chinese patent application number 202220102253.X, filed on Jan. 14, 2022, the entire disclosures of which are expressly incorporated herein by reference.

### FIELD OF DISCLOSURE

The present disclosure relates to a water treatment device, and in particular to a filter device.

### BACKGROUND OF THE DISCLOSURE

A water purifier may filter out harmful substances and purify water in a swimming pool. This filtering work is completed by the filter of the water purifier. The filter has a service life and needs to be replaced.

A conventional water purifier is disclosed in Chinese patent publication number CN208757088U and includes an indicator for the state of a water purifier filter element. The disclosed water purification water supply system includes a fixed structure, a status indicator light, and a signal line.

In other current traditional water purification filtration devices, the prompts for replacing the filter medium are mostly the following two: (1) The user regularly disassembles and checks the dirty condition of the filter medium—this method is troublesome to operate, and the accuracy is not high; and (2) The user is reminded to replace the filter medium through a pressure gauge or a pressure sensor—this method has high precision, but the product cost increases a lot.

If the filter has not been replaced for a long time, it may cause the filter to be blocked due to excessive impurities on the filter, which will eventually cause the filter to be damaged. Therefore, the user needs to be reminded when the filter is clogged or the filter device is functioning abnormally.

### SUMMARY OF THE DISCLOSURE

An exemplary technical problem solved by various embodiments of the present disclosure is to provide a filter medium contamination detection structure that is low cost and convenient to use.

In order to solve the above technical problem, in a preferred embodiment, a filter medium contamination detection structure is provided. The filter medium contamination detection structure may comprise a controller, a filter element, and a prompt assembly. The controller may comprise a signal input end and a signal output end. The prompt assembly may comprise a first pressure sensor comprising a signal output end and a second pressure sensor comprising a signal output end. The first pressure sensor may be connected to a water inlet of the filter element and the second pressure sensor may be connected to a water outlet end of the filter element or outside air. The signal output ends of the first pressure sensor and the second pressure sensor may be connected to the signal input end of the controller. When the filter element is dirty, the pressure at the inlet end increases or the pressure at the outlet end decreases, and the difference between the first sensor and the second pressure sensor increases.

In another preferred embodiment, the first pressure sensor and the second pressure sensor may be fixed on the outside of a filter cartridge, and the filter element may be arranged in the filter cartridge.

In yet another preferred embodiment, two flow holes may be arranged through a cylindrical wall of the filter cartridge along the thickness direction.

In still another preferred embodiment, the prompt assembly may comprise two tympanic membranes, a fixing plate, a support member, and a gland. The tympanic membranes may be clamped between the cylinder wall of the filter cartridge and the fixing plate, and the tympanic membrane may be correspondingly arranged at the flow hole. The support member may be clamped between the fixing plate and the gland, and the support member may have mounting cavities corresponding to the tympanic membrane one-to-one for mounting the first pressure sensor and the second pressure sensor.

In another preferred embodiment, one of the flow holes may be arranged on the wall of the inlet waterway of the filter cartridge, and the other flow hole may be arranged on the wall of the outlet waterway of the filter cartridge.

In yet another preferred embodiment, the prompt assembly may be connected to the filter cartridge through a connecting pipe.

In still another preferred embodiment, the prompt assembly may comprise an upper fixing plate and a lower fixing plate. The tympanic membranes may be clamped between the lower fixing plate and the upper fixing plate. The lower fixing plate may be provided with a water passage connecting the connecting pipe and the tympanic membrane. The support member may be clamped between the gland and the upper fixing plate, and the first pressure sensor and the second pressure sensor may be in one-to-one correspondence with the tympanic membrane and may abut with the back of the tympanic membrane.

In yet another preferred embodiment, the output end of the controller may be connected to a contamination alarm prompt module. When the difference of the first pressure sensor and the second pressure sensor reaches a set threshold, the controller may output a control signal to control the action of the contamination alarm prompting module.

In still another preferred embodiment, the action of the contamination alarm prompt module may refer to one or more of sound prompt, light prompt, voice prompt, and mobile phone APP (application) prompt.

Embodiments of the present disclosure may further provide a filter device, which may be equipped with the filter medium contamination detection structure.

Compared with the prior art, the technical solution of embodiments of the present disclosure may have at least the following beneficial effects.

Embodiments of the present disclosure may provide a filter medium contamination detection structure. By arranging two pressure sensors, the two pressure sensors may be installed before and after the filter element and may indicate the filter medium is dirty by utilizing the characteristic that the pressure of the water inlet end rises after the filter element is dirty. When the pressure difference of the sensor changes, and the controller detects the change of the pressure difference, the user may be reminded when the pressure difference reaches the set threshold.

An exemplary technical problem solved by various embodiments of the present disclosure is to provide a filter with abnormal warning function, which reminds the user when the product has no internal water flow due to a fault.

In order to solve the above-mentioned technical problem, a preferred embodiment of the present disclosure may provide a filter with abnormal warning function, which comprises a filter body and a warning signal generating assembly. The warning signal generating assembly may be arranged in a water flow passage of the filter body. The warning signal generating assembly may comprise a movable member and a signal generating member matched with the movable member. The movable member may be respectively located at a first position and a second position when there is water flow in the water flow passage and when there is no water flow in the water flow passage. When the movable member is located at the second position, the movable member may cooperate with the signal generating member to make the signal generating member send out a warning signal.

In another preferred embodiment, the warning signal generating assembly may comprise a swing arm arranged between a water inlet end and a water outlet end of the water flow passage, a flow switch connected to the free end of the swing arm and a circuit board. When there is water flow in the water flow passage, the water flow drives the swing arm to move in the direction close to the circuit board, so that the flow switch cooperates with the Hall element, and the swing arm accumulates elastic restoring force. When there is no water flow in the water flow passage, the swing arm moves in the direction away from the circuit board under the action of the elastic restoring force to release the cooperation between the flow switch and the Hall element.

In yet another preferred embodiment, the warning signal generating assembly may comprise a swing arm arranged between a water inlet end and a water outlet end of the water flow passage, a flow switch connected to the free end of the swing arm and a circuit board. When there is water flow in the water flow passage, the water flow drives the swing arm to move in the direction close to the circuit board, so that the flow switch is released from the Hall element, and the swing arm accumulates elastic restoring force. When there is no water flow in the water flow passage, the swing arm moves in the direction away from the circuit board under the action of the elastic restoring force, so that the flow switch and the Hall element cooperate.

In still another preferred embodiment, the warning signal generating assembly may be arranged between a water inlet end and a water outlet end of the water flow passage, and the warning signal generating assembly comprises a micro-switch, a valve rod and an elastic member. One end of the valve rod may be linked with the elastic member, and the other end may be used to cooperate with the micro-switch. When there is water flow in the water flow passage, the water flow drives the valve rod to squeeze the elastic member, so that the valve rod moves to the first position where the other end of the valve rod is separated from the micro-switch. When there is no water flow in the water flow passage, the elastic restoring force of the elastic member drives the valve rod to move to the second position where the other end of the valve rod abuts against the micro-switch.

In another preferred embodiment, the warning signal generating assembly may be arranged between a water inlet end and a water outlet end of the water flow passage, and the warning signal generating assembly comprises a micro-switch, a valve rod, and an elastic member. One end of the valve rod may be linked with the elastic member, and the other end may be used to cooperate with the micro-switch. When there is water flow in the water flow passage, the water flow drives the valve rod to squeeze the elastic member, so that the valve rod moves to the first position where the other end of the valve rod is in contact with the micro-switch. When there is no water flow in the water flow passage, the elastic restoring force of the elastic member drives the valve rod to move to the second position where the other end of the valve rod is separated from the micro-switch.

In yet another preferred embodiment, the warning signal generating assembly may comprise an elastic member, a flow switch, a circuit board, and a valve rod. One end of the valve rod may be linked to the elastic member and the flow switch may be fixed on the valve rod. The circuit board may be provided with a Hall element. When there is water flow in the water flow passage, the water flow squeezes the elastic member to drive the flow switch to cooperate with the Hall element. When there is no water flow in the water flow passage, the elastic member resets and drives the flow switch to disengage the Hall element.

In still another preferred embodiment, the warning signal generating assembly may comprise an elastic member, a flow switch, a circuit board, and a valve rod. One end of the valve rod may be linked to the elastic member and the flow switch may be fixed on the valve rod. The circuit board may be provided with a Hall element. When there is water flow in the water flow passage, the water flow squeezes the elastic member to drive the flow switch to disengage from the Hall element. When there is no water flow in the water flow passage, the elastic member resets and drives the flow switch to cooperate with the Hall element.

In another preferred embodiment, the warning signal generating assembly may comprise an elastic member, a flow switch, a circuit board, and a valve rod. One end of the valve rod may be linked to the elastic member and the flow switch may be fixed on the valve rod. The circuit board may be provided with a micro-switch. When there is water flow in the water flow passage, the water flow squeezes the elastic member to drive the flow switch to disengage from the micro-switch. When there is no water flow in the water flow passage, the elastic member resets and drives the flow switch to cooperate with the micro-switch.

In yet another preferred embodiment, the warning signal generating assembly may comprise an elastic member, a flow switch, a circuit board, and a valve rod. One end of the valve rod may be linked to the elastic member and the flow switch may be fixed on the valve rod. The circuit board may be provided with a micro-switch. When there is water flow in the water flow passage, the water flow squeezes the elastic member to drive the flow switch to cooperate with the micro-switch. When there is no water flow in the water flow passage, the elastic member resets to drive the flow switch to disengage the micro-switch.

In still another preferred embodiment, the warning signal may be one or more of a sound signal, a photoelectric signal, a vibration signal, and an APP (application) prompt signal.

Compared with the prior art, the technical solution of embodiments of the present disclosure may have at least the following beneficial effects.

Embodiments of the present disclosure provide a filter with abnormal warning function, which utilizes the difference between whether the filter has water flow under normal use and abnormal use and uses the driving force of the water flow to move the position of the warning signal generating assembly, thereby realizing the warning occurrence of the signal. In this way, the user may know in time that the filter has failed and needs to be replaced.

### BRIEF DESCRIPTION OF THE DRAWINGS

The foregoing aspects and many of the intended advantages of this disclosure will become more readily appreciated as the same becomes better understood by reference to the following detailed description when taken in conjunction with the accompanying drawings.

FIG. 1 illustrates a perspective view of an exemplary embodiment of a filter device including the filter medium contamination detection structure of the present disclosure;

FIG. 2 illustrates a partial cross-sectional view of an exemplary filter medium contamination detection structure of the present disclosure;

FIG. 3 illustrates a partial exploded view of the filter medium contamination detection structure of FIG. 2;

FIG. 4 illustrates a partial cross-sectional view of another exemplary filter medium contamination detection structure of the present disclosure;

FIG. 5 illustrates a partial exploded view of the exemplary filter medium contamination detection structure of FIG. 4;

FIG. 6 illustrates a schematic diagram of an exemplary filter having abnormal warning function of the present disclosure, the exemplary filter depicted in a normal use state;

FIG. 7 illustrates a schematic diagram of the exemplary filter of FIG. 6, the exemplary filter depicted in an abnormal use state;

FIG. 8 illustrates a schematic diagram of another exemplary filter having abnormal warning function of the present disclosure, the exemplary filter depicted in a normal use state;

FIG. 9 illustrates a schematic diagram of the exemplary filter of FIG. 8, the exemplary filter depicted in an abnormal use state;

FIG. 10 illustrates a schematic diagram of yet another exemplary filter having abnormal warning function of the present disclosure, the exemplary filter depicted in a normal use state;

FIG. 11 illustrates a schematic diagram of the exemplary filter of FIG. 10, the exemplary filter depicted in an abnormal use state;

FIG. 12 illustrates a schematic diagram of still another exemplary filter having abnormal warning function of the present disclosure, the exemplary filter depicted in a normal use state;

FIG. 13 illustrates a schematic diagram of the exemplary filter of FIG. 12, the exemplary filter depicted in an abnormal use state;

FIG. 14 illustrates a schematic diagram of the cooperation between an exemplary valve rod and an exemplary micro-switch of the exemplary filter of FIG. 12;

FIG. 15 illustrates a schematic diagram of the disengagement of the valve rod and the micro-switch of FIG. 14;

FIG. 16 illustrates an exploded view of an exemplary filter having abnormal warning function of the present disclosure;

FIG. 17 illustrates a schematic diagram of the exemplary filter of FIG. 16 when there is no water flow;

FIG. 18 illustrates a schematic diagram of the exemplary filter of FIG. 16 when the water flow is small;

FIG. 19 illustrates a schematic diagram of the exemplary filter of FIG. 16 when the water flow is normal.

Corresponding reference characters indicate corresponding parts throughout the several views. Although the drawings represent embodiments of various features and components according to the present disclosure, the drawings are not necessarily to scale and certain feature may be exaggerated in order to better illustrate and explain the present disclosure. The exemplifications set out herein illustrate embodiments of the disclosure, and such exemplifications are not to be construed as limiting the scope of the disclosure in any manner.

### DETAILED DESCRIPTION OF THE DRAWINGS

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

In the description of the present disclosure, it should be noted that the terms “upper”, “lower”, “inner”, “outer”, “top/bottom”, etc. indicate the orientation or positional relationship based on the orientation shown in the drawings. The positional relationship is only for the convenience of describing the present disclosure and simplifying the description, rather than indicating or implying that the referenced device or element must have a specific orientation, be constructed, and be operated in a specific orientation. Therefore, the positional relationship should not be understood as a limitation of the present disclosure. In addition, the terms “first” and “second” are only used for descriptive purposes and should not be understood as indicating or implying relative importance.

In the description of the present disclosure, it should be noted that the terms “installed”, “provided with”, “sleeved/connected”, “connected”, etc., should be understood broadly. For example, “connected” can be a fixed connection, a detachable connection, or an integral connection, a mechanical connection, an electrical connection, a direct connection, or an indirect connection through an intermediate medium, and it can be a connection between two members. For those of ordinary skill in the art, the specific meaning of the above terms in the present disclosure can be understood under specific conditions. The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other). Filter Medium Contamination Detection Structure

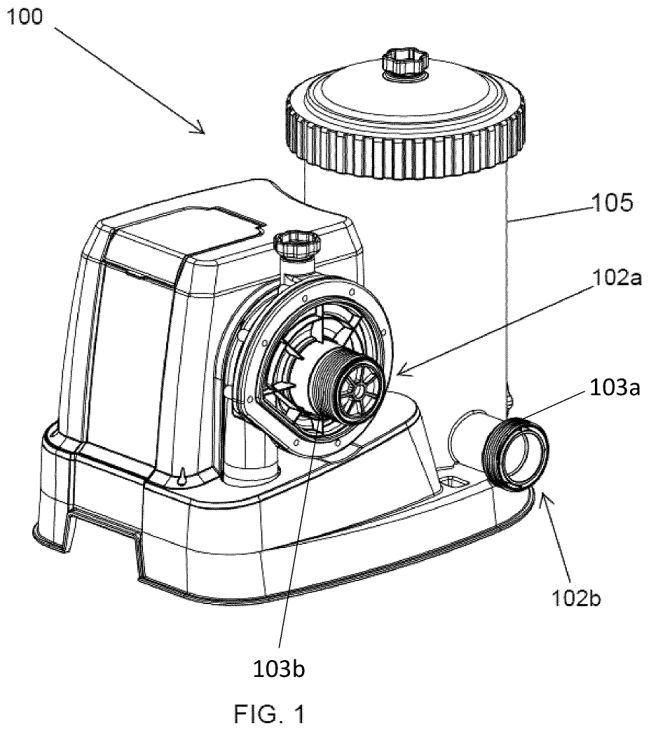

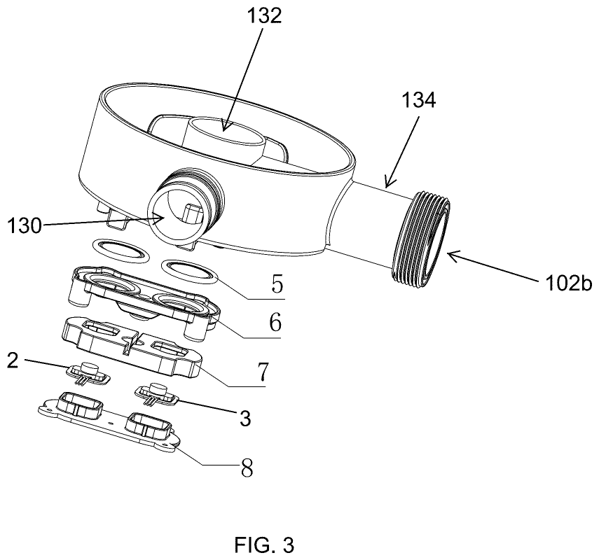

Referring to FIGS. 1-3, an exemplary filter device 100 including an exemplary filter medium contamination detection structure is shown. The exemplary filter device 100 includes fluid inlet 102a, fluid outlet 102b, and filter cartridge 105. Fluid inlet 102a and fluid outlet 102b may be coupled to a swimming pool, spa, or other suitable fluid reservoir having fluid to be cleaned.

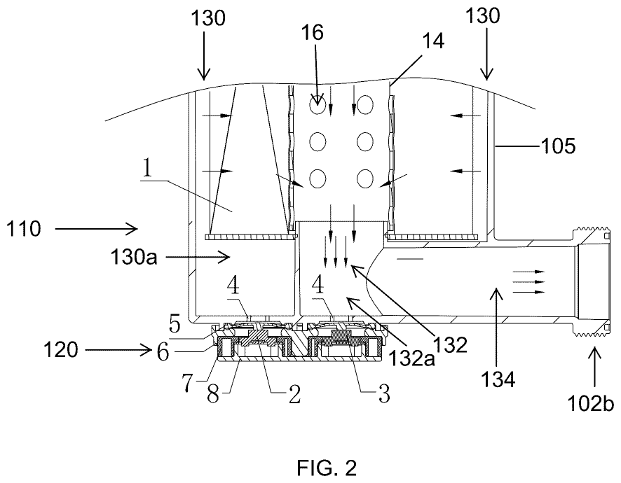

As stated, the exemplary filter device 100 includes an exemplary filter medium contamination detection structure 110, which is arranged inside filter cartridge 105. The exemplary filter medium contamination detection structure 110 may include a filter element 1, which surrounds a central core 14 having openings 16 therein, and a prompt assembly 120. As illustrated in FIG. 2, filter element 1 may include water inlet 130, which is in fluid communication with fluid inlet 102a, and water outlet 132, which is in fluid communication with fluid outlet 102b via passageway 134.

As illustrated in FIG. 2, the prompt assembly 120 may include a first pressure sensor 2 and a second pressure sensor 3. The first pressure sensor 2 is in fluid communication with water inlet 130 of the filter element 1. The second pressure sensor 3 is in fluid communication with water outlet 132 of the filter element 1 or the outside air. Signal output ends (not shown) of the first pressure sensor 2 and the second pressure sensor 3 are connected to the signal input end of the controller (not shown).

When the filter element 1 is dirty, the pressure at the water inlet 130 increases or the pressure at the water outlet 132 decreases. Thus, when the filter element 1 is dirty, the difference between the pressure detected by the first sensor 2 and the second pressure sensor 3 increases.

As presented above, the exemplary filter medium contamination detection structure 110 may be provided with two pressure sensors 2, 3. The pressure difference between the two pressure sensors 2, 3 before and after the filter element 1 is dirty changes by using the characteristics of the pressure rise at the inlet after the filter element 1 is dirty. The controller detects the change in the pressure difference, and the user can be reminded when the pressure difference reaches the set threshold.

In this exemplary embodiment, the prompt assembly 120 is directly installed on the filter cartridge 105, so the first pressure sensor 2 and the second pressure sensor 3 are fixed on the outside of the filter cartridge 105, and the filter element 1 is arranged in the filter cartridge 105.

Then, in order to fix the pressure sensors 2, 3 and to detect the pressure at the water inlet 130 and the water outlet 132, two flow holes 4 are provided through the wall of the filter cartridge 105 along the thickness direction.

The prompt assembly 120 may include two tympanic membranes 5, a fixing plate 6, a support member 7, and a gland 8. The tympanic membranes 5 may be clamped between the wall of the filter cartridge 105 and the fixing plate 6, and the tympanic membranes 5 may be correspondingly disposed at the flow holes 4. The support member 7 may be clamped between the fixing plate 6 and the gland 8, and the support member 7 may have mounting cavities corresponding to the tympanic membrane 5 one-to-one for mounting the first pressure sensor 2 and second pressure sensor 3.

Since the tympanic membrane 5 and the pressure sensors 2, 3 are to detect the pressure of the water inlet 130 and outlet 132, one of the flow holes 4 is arranged on the wall of the inlet waterway 130a of the filter cartridge 105, and the other flow hole 4 is arranged on the wall of the outlet waterway 132a of the filter cartridge 105. As pressure increases at water inlet 130 due to contamination of filter 1, the pressure increase is translated to the tympanic membrane 5 corresponding to the first pressure sensor 2. Conversely, as pressure decreases at water outlet 132 due to contamination of filter 1, the pressure decrease is translated to the tympanic membrane 5 corresponding to the second pressure sensor 3. The signal outputs of the pressure sensors 2, 3 allow the pressure sensors 2, 3 to communicate the pressure differential to the controller via the controller's signal input.

The above solution realizes the detection of whether the filter cartridge is dirty, and then the user needs to be notified to replace or clean the filter cartridge after it is dirty. Therefore, the output end of the controller may be connected to a contamination alarm prompt module (not shown). When the difference between the first pressure sensor and the second pressure sensor 3 reaches a set threshold, the controller outputs a control signal to control the action of the contamination alarm prompts module.

In this exemplary embodiment, the action of the contamination alarm prompt module may refer to one or more of a sound prompt, a light prompt, a voice prompt, and a mobile phone APP (application) prompt.

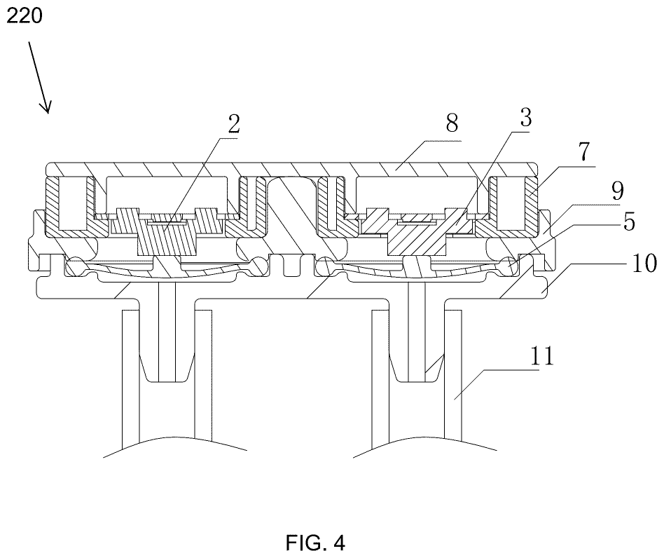

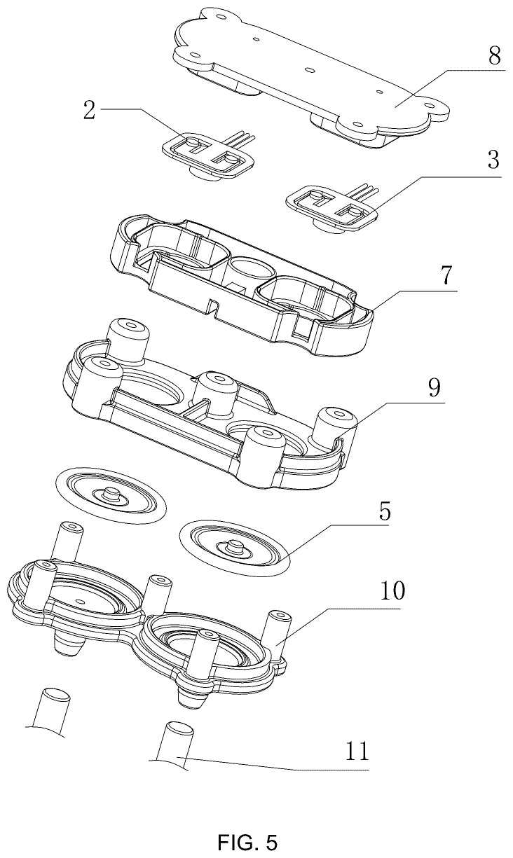

Referring to FIG. 4 and FIG. 5, in this exemplary embodiment, the prompt assembly 220 is connected to the filter cartridge 105 through a connecting pipe 11.

As illustrated in FIG. 4, the prompt assembly may include two tympanic membranes 5, a gland 8, a support member 7, an upper fixing plate 9, and a lower fixing plate 10. The tympanic membranes 5 are clamped between the lower fixing plate 10 and the upper fixing plate 9. The lower fixing plate 10 may be provided with the water passage that communicates the connecting pipe and tympanic membrane 5. The support member 7 may be clamped between gland 8 and the upper fixing plate 9, and the support member 7 may have mounting cavities for mounting the first pressure sensor 2 and the second pressure sensor 3. The first pressure sensor 2 and the second pressure sensor 3 are in one-to-one correspondence with the tympanic membrane 5 and abut against the back of the tympanic membrane 5.

### Filter Having Abnormal Warning Function

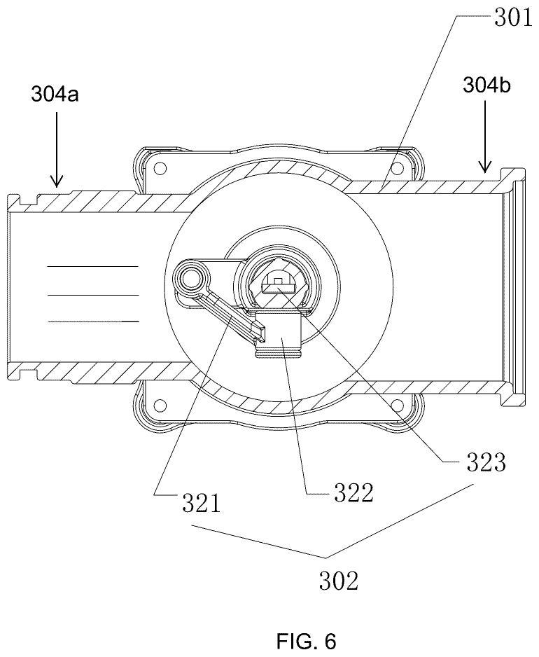

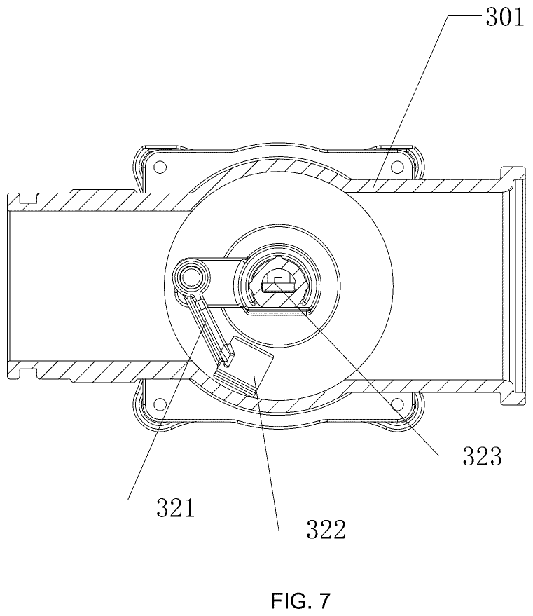

Referring to FIG. 6 and FIG. 7, an exemplary filter with abnormal warning function is shown. As illustrated, the exemplary filter may include a filter body 301 and a warning signal generating assembly 302 positioned inside the filter body 301. The exemplary filter further includes water inlet end 304a and water outlet end 304b. The warning signal generating assembly 302 is depicted between the water inlet end 304a and the water outlet end 304b.

As illustrated in FIG. 6 and FIG. 7, the warning signal generating assembly 302 may be arranged in the water flow passage of the filter body 301. The warning signal generating assembly 302 may include a movable member that moves in response to water flow through the water flow passage of filter body 301 and a signal generating member matched with the movable member. FIG. 6 depicts the movable member in a first position wherein there is water flow through the water flow passage of filter body 301. FIG. 7 depicts the movable member in a second position wherein there is no water flow through the water flow passage of filter body 301. When the movable member is in the second position, the movable member cooperates with the signal generating member, which results in the signal generating member sending out a warning signal.

The above-mentioned exemplary filter with abnormal warning function utilizes the difference between whether the filter has water flow under normal use and abnormal use, and uses the driving force of the water flow to move the warning signal generating assembly 302 to change its position, thereby realizing the generation of the warning signal. In this way, the user can know in time that the filter has failed and needs to be replaced.

In this exemplary embodiment, in order to achieve the above effects, the warning signal generating assembly 302 comprises a swing arm 321 disposed between the water inlet end 302a and the water outlet end 304b of the water flow passage, a flow switch 322 connected to the free end of the swing arm 321, and a circuit board including a Hall element 323. When there is water flow in the water flow passage, the water flow drives the swing arm 321 to move toward the direction close to the circuit board, so that the flow switch 322 cooperates with the Hall element 323, and the swing arm 321 accumulates elastic restoring force. When there is no water flow in the water flow passage, the swing arm 321 swings in the direction away from the circuit board under the action of the elastic restoring force, so as to release the cooperation between the flow switch 322 and the Hall element 323. The elastic restoring effect, in embodiments, is provided with a spring element, such as a torsional spring.

As a simple replacement of this exemplary embodiment, it can also be set that when there is water flow in the water flow passage, the water flow drives the swing arm 321 to move toward the direction away from the circuit board which may be placed on an inner wall of the filter body 301, so that the flow switch 322 is released from the cooperation with the Hall element 323, and the swing arm 321 accumulates elastic restoring force. When there is no water flow in the water passage, the swing arm 321 shown swings away from the circuit board under the action of the elastic restoring force, so that the flow switch 322 and the Hall element 323 cooperate.

In short, the flow switch 322 at one position is engaged with the Hall element 323, and the flow switch 322 at the other position can be disengaged with the Hall element 323.

In this exemplary embodiment, the warning signal may be one or more of a sound signal, a photoelectric signal, a vibration signal, and an APP (application) prompt signal.

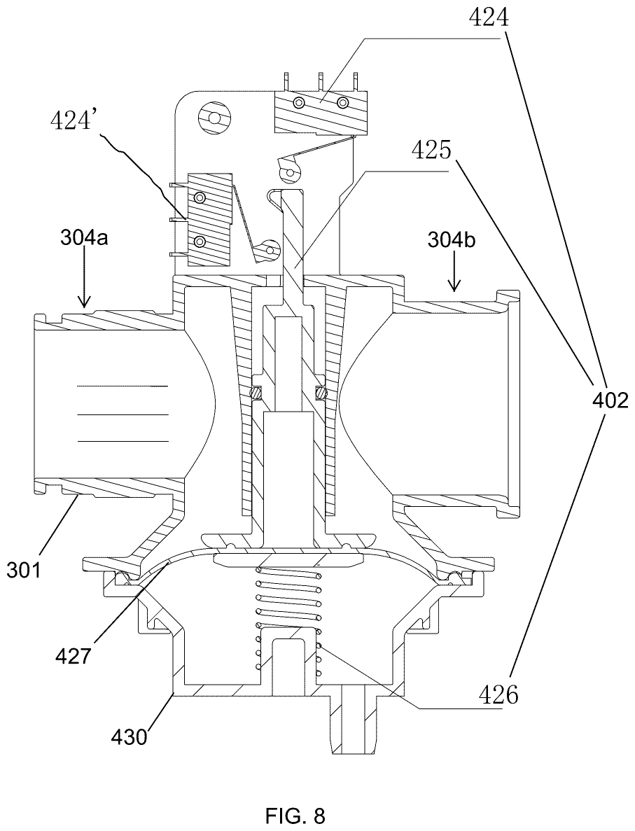

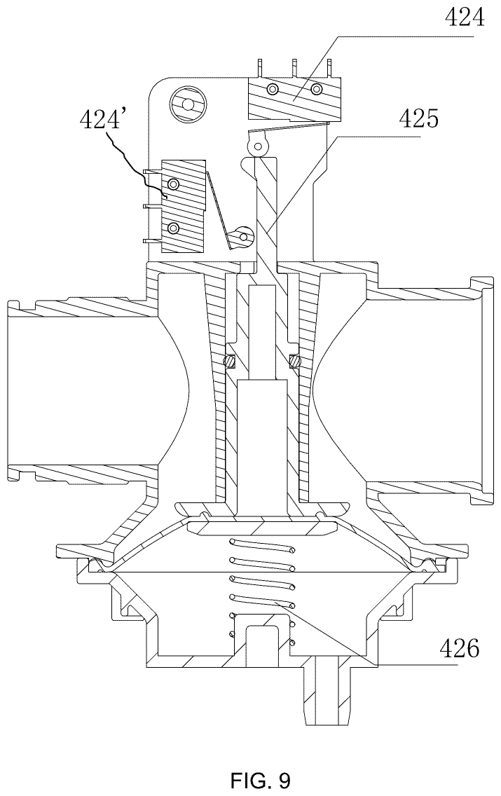

Referring to FIG. 8 and FIG. 9, in this exemplary embodiment, the warning signal generating assembly 402 is disposed between the water inlet end 304a and the water outlet end 304b of the filter body 301. As illustrated, the warning signal generating assembly 402 may include a micro-switch 424, a valve rod 425, and an elastic member 426. One end of the valve rod 25 is linked with the elastic member 26, and the other end is used to cooperate with the micro-switch 24. The warning signal generating assembly 402 may further include a diaphragm 427 disposed between the elastic member 426 and the valve rod 425. The diaphragm 427 may further be housed between a lower valve chamber 430 of the filter body 301.

When there is water flow in the water flow passage, the water flow drives the valve rod 425 to squeeze the elastic member 426, so that the valve rod 425 moves to a first position where the other end of the valve rod 425 is separated from the micro-switch 424. When there is no water flow in the water flow passage, the elastic restoring force of the elastic member 426 drives the valve rod 425 to move to a second position where the other end of the valve rod 425 is in contact with the micro-switch 424.

Similarly, as a simple replacement, it can also be set that when there is water flow in the water flow passage, the water flow drives the valve rod 425 to squeeze the elastic member 426, so that the valve rod 425 moves until the other end of the valve rod 425 abuts against the micro-switch 424′. When there is no water flow in the water passage, the elastic restoring force of the elastic member 426 drives the valve rod 425 to move to a second position where the other end of the valve rod 425 is separated from the micro-switch 424′.

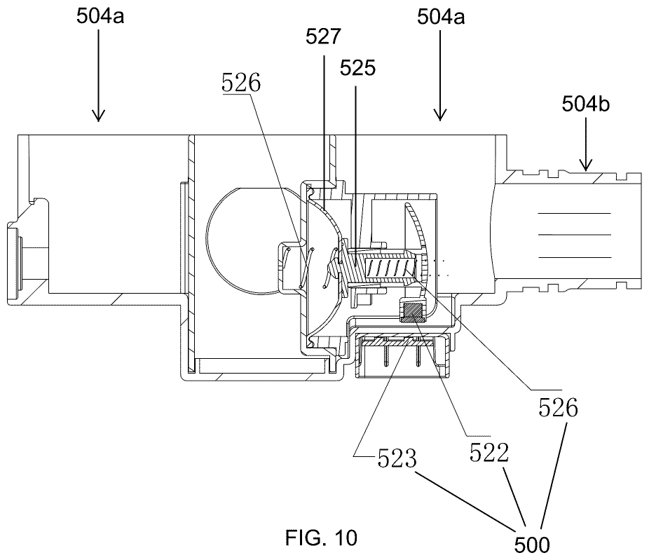

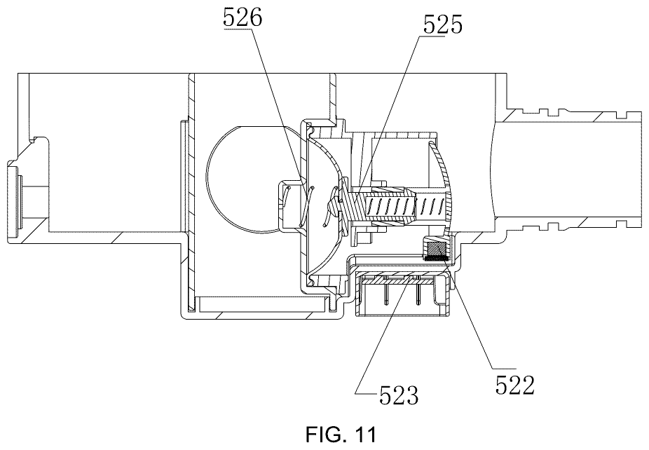

Referring to FIG. 10 and FIG. 11, in this exemplary embodiment, the warning signal generating assembly 500 may include an elastic member 526, a flow switch 522, a circuit board and a valve rod 525, and a diaphragm 527. One end of the valve rod 525 may be linked with the elastic member 526, and the flow switch 522 is fixed on the valve rod 525. The circuit board is provided with a Hall element 523.

When there is water flow from water inlet end 504a to water outlet end 504b of the water flow passage, the water flow squeezes the elastic member 526 to drive the flow switch 522 to cooperate with the Hall element 523.

Similarly, as a simple replacement of this embodiment, it can also be set that when there is water flow in the water flow passage, the water flow squeezes the elastic member 526 to drive the flow switch 522 to disengage the Hall element 523 by changing the location of the Hall element 523 or flow switch 522. When there is no water flow in the water flow passage, the elastic element 526 resets and drives the flow switch 522 to cooperate with the Hall element 523.

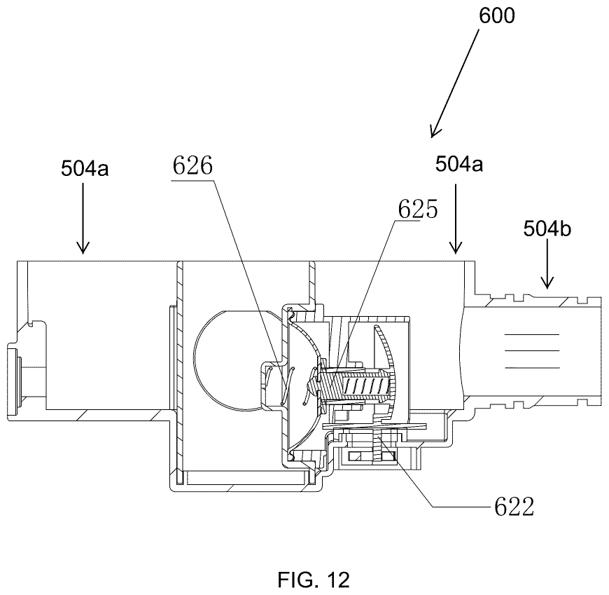

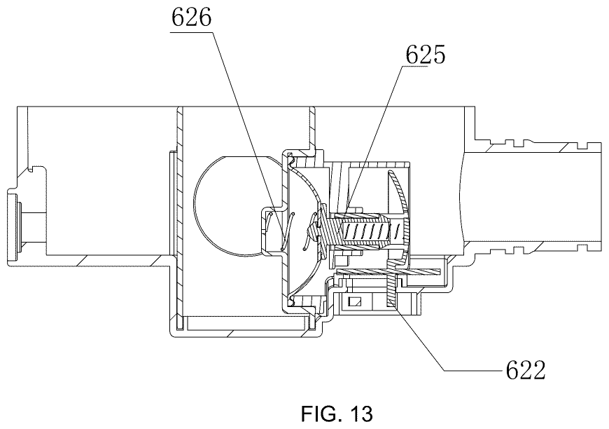

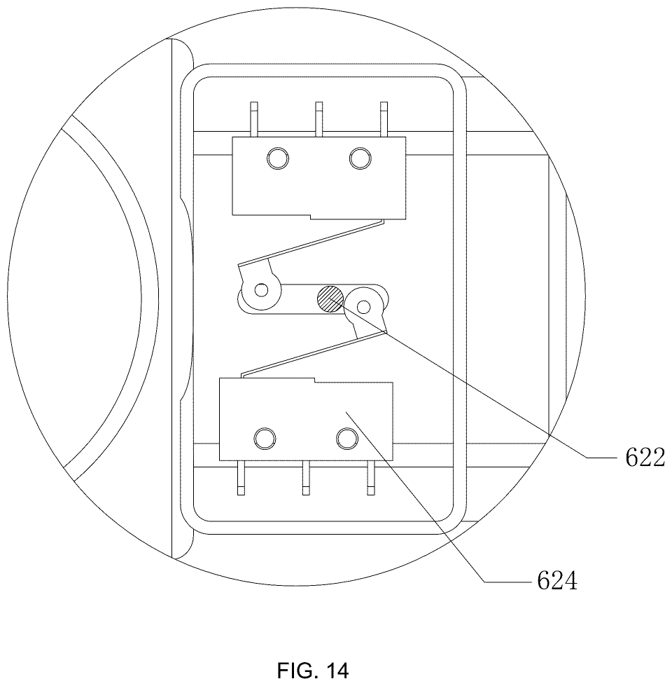

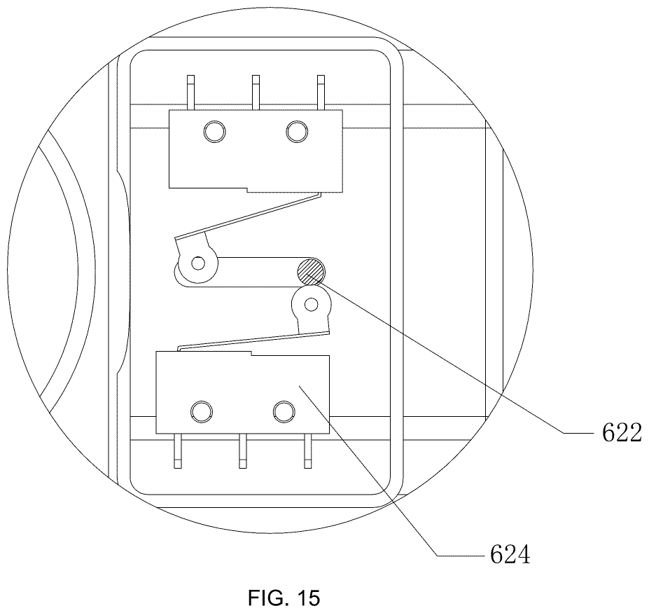

Referring to FIGS. 12-15, in this exemplary embodiment, the warning signal generating assembly 602 may include an elastic member 626, a flow switch 622, a circuit board and a valve rod 625. One end of the valve rod 625 may be linked with the elastic member 626, and the flow switch 622 is fixed on the valve rod 625. The circuit board may be provided with a micro-switch 624. When there is water flow from water inlet end 504a to the outlet end 504b of the water flow passage, the water flow squeezes the elastic member 626 to drive the flow switch 622 to disengage from the micro-switch 624. Similarly, as a simple replacement of this exemplary embodiment, it can also be set that when there is water flow in the water flow passage, the water flow squeezes the elastic member 626 to drive the flow switch 622 to cooperate with the micro-switch 624. And when there is no water flow in the water flow passage, the elastic member 626 resets and drives the flow switch 622 to disengage from the micro-switch 624.

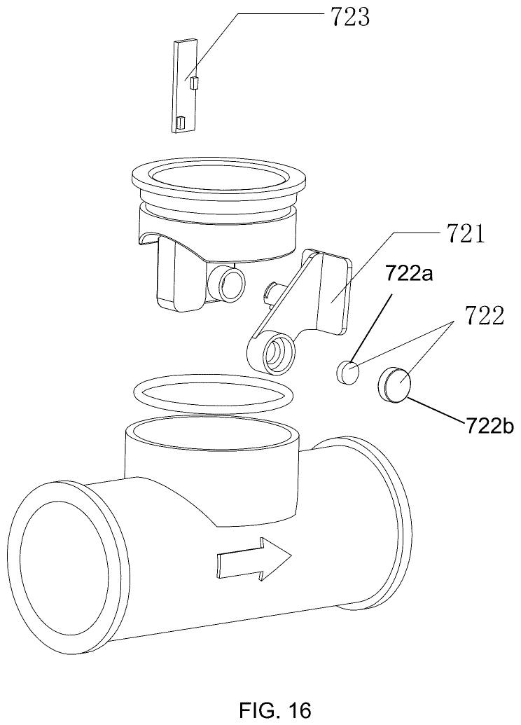

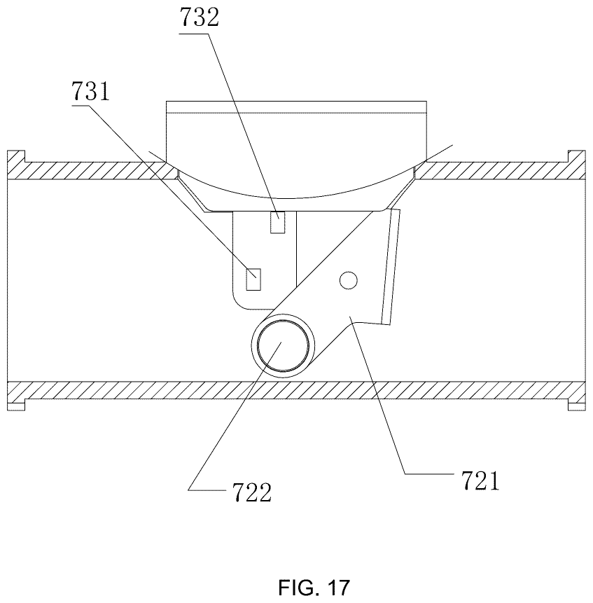

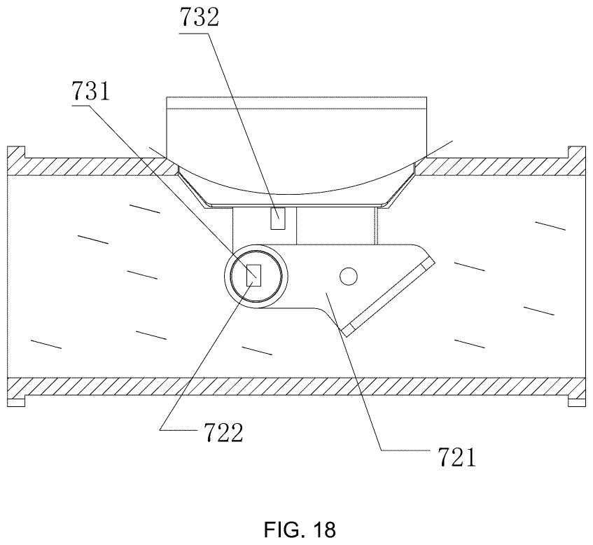

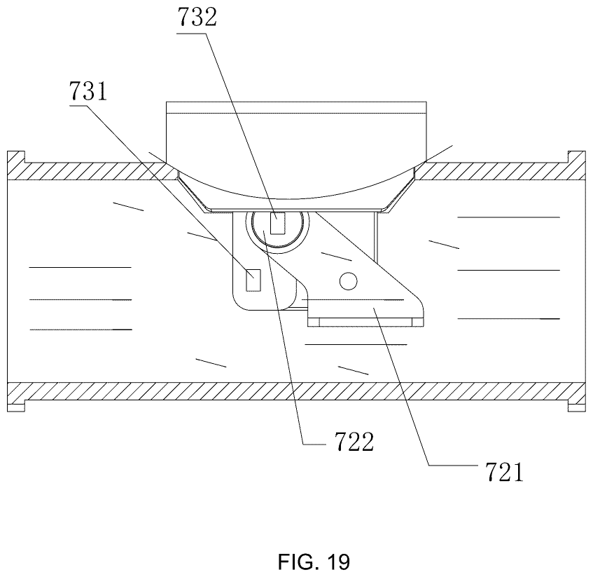

Referring to FIGS. 16-19, the difference between this exemplary embodiment and the exemplary embodiment depicted in FIGS. 6 and 7 is that there is only one Hall element 323 in the exemplary embodiment of FIGS. 6 and 7, and only water flow or no water flow can be distinguished. In this exemplary embodiment, there are two Hall elements 723. When there is no water, the flow switch 722, which includes magnet 722a and magnet cover 722b, on the swing arm 721 does not cooperate with any one of the Hall elements 723. When there is water or the water flow is relatively small, the flow switch 722 on the swing arm 721 cooperates with the first Hall element 731. When there is water and the water flow is normal, the flow switch 722 on the swing arm 721 cooperates with the second Hall element 732.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

1-10. (canceled)

11. A filter with abnormal warning function, comprising:
a filter body, and
a warning signal generating assembly arranged in a water flow passage of the filter body, the warning signal generating assembly comprises a movable member and a signal generating member matched with the movable member, and the movable member is respectively located at a first position and a second position when there is water flow in the water flow passage and when there is no water flow in the water flow passage;
when the movable member is located at the second position, the movable member cooperates with the signal generating member to make the signal generating member send out a warning signal.

12. The filter with abnormal warning function according to claim 11, wherein the warning signal generating assembly comprises a swing arm arranged between a water inlet end and a water outlet end of the water flow passage, a flow switch connected to the free end of the swing arm and a circuit board; when there is water flow in the water flow passage, the water flow drives the swing arm to move in a direction close to the circuit board, so that the flow switch cooperates with the Hall element, and the swing arm accumulates elastic restoring force; when there is no water flow in the water flow passage, the swing arm moves in the direction away from the circuit board under the action of the elastic restoring force to release the cooperation between the flow switch and the Hall element.

13. The filter with abnormal warning function according to claim 11, wherein the warning signal generating assembly comprises a swing arm arranged between a water inlet end and a water outlet end of the water flow passage, a flow switch connected to the free end of the swing arm and a circuit board; when there is water flow in the water flow passage, the water flow drives the swing arm to move in the direction close to the circuit board, so that the flow switch is released from the Hall element, and the swing arm accumulates elastic restoring force; when there is no water flow in the water flow passage, the swing arm moves in the direction away from the circuit board under the action of the elastic restoring force, so that the flow switch and the Hall element cooperate.

14. The filter with abnormal warning function according to claim 11, wherein the warning signal generating assembly is arranged between a water inlet end and a water outlet end of the water flow passage, and the warning signal generating assembly comprises a micro-switch, a valve rod and an elastic member; one end of the valve rod is linked with the elastic member, and the other end is used to cooperate with the micro-switch; when there is water flow in the water flow passage, the water flow drives the valve rod to squeeze the elastic member, so that the valve rod moves to the first position where the other end of the valve rod is separated from the micro-switch; when there is no water flow in the water flow passage, the elastic restoring force of the elastic member drives the valve rod to move to the second position where the other end of the valve rod abuts against the micro-switch.

15. The filter with abnormal warning function according to claim 11, wherein the warning signal generating assembly is arranged between a water inlet end and a water outlet end of the water flow passage, and the warning signal generating assembly comprises a micro-switch, a valve rod and an elastic member; one end of the valve rod is linked with the elastic member, and the other end is used to cooperate with the micro-switch; when there is water flow in the water flow passage, the water flow drives the valve rod to squeeze the elastic member, so that the valve rod moves to the first position where the other end of the valve rod is in contact with the micro-switch; when there is no water flow in the water flow passage, the elastic restoring force of the elastic member drives the valve rod to move to the second position where the other end of the valve rod is separated from the micro-switch.

16. The filter with abnormal warning function according to claim 11, wherein the warning signal generating assembly comprises an elastic member, a flow switch, a circuit board and a valve rod; one end of the valve rod is linked to the elastic member, the flow switch is fixed on the valve rod; the circuit board is provided with a Hall element; when there is water flow in the water flow passage, the water flow squeezes the elastic member to drive the flow switch to cooperate with the Hall element; when there is no water flow in the water flow passage, the elastic member resets and drives the flow switch to disengage the Hall element.

17. The filter with abnormal warning function according to claim 11, wherein the warning signal generating assembly comprises an elastic member, a flow switch, a circuit board and a valve rod; one end of the valve rod is linked to the elastic member, the flow switch is fixed on the valve rod; the circuit board is provided with a Hall element; When there is water flow in the water flow passage, the water flow squeezes the elastic member to drive the flow switch to disengage from the Hall element; when there is no water flow in the water flow passage, the elastic member resets and drives the flow switch to cooperate with the Hall element.

18. The filter with abnormal warning function according to claim 11, wherein the warning signal generating assembly comprises an elastic member, a flow switch, a circuit board and a valve rod; one end of the valve rod is linked to the elastic member, the flow switch is fixed on the valve rod; the circuit board is provided with a micro-switch; when there is water flow in the water flow passage, the water flow squeezes the elastic member to drive the flow switch to disengage from the micro-switch; when there is no water flow in the water flow passage, the elastic member resets and drives the flow switch to cooperate with the micro-switch.

19. The filter with abnormal warning function according to claim 11, wherein the warning signal generating assembly comprises an elastic member, a flow switch, a circuit board and a valve rod; one end of the valve rod is linked to the elastic member, the flow switch is fixed on the valve rod; the circuit board is provided with a micro-switch; when there is water flow in the water flow passage, the water flow squeezes the elastic member to drive the flow switch to cooperate with the micro-switch; when there is no water flow in the water flow passage, the elastic member resets to drive the flow switch to disengage the micro-switch.

20. The filter with abnormal warning function according to claim 11, wherein the warning signal is one or more of a sound signal, a photoelectric signal, a vibration signal, and an APP prompt signal.

21. A filter device, comprising:
a fluid inlet including a fluid inlet coupling;
a fluid outlet including a fluid outlet coupling;
a filter element including an inlet in fluid communication with the fluid inlet and an outlet in fluid communication with the fluid outlet; and
a prompt assembly, wherein the prompt assembly comprises a first pressure sensor comprising a signal output end and a second pressure sensor comprising a signal output end, wherein the first pressure sensor is connected to the inlet of the filter element, and the second pressure sensor is connected to the outlet of the filter element or outside air, and wherein the signal output ends of the first pressure sensor and the second pressure sensor are connected to a signal input end of a controller;
when the filter element is dirty, a pressure at the inlet increases or a pressure at the outlet decreases, and the difference between the first sensor and the second pressure sensor increases.

22. The filter device according to claim 21, further comprising a filter cartridge, wherein the filter element further comprises first pressure sensor and the second pressure sensor are fixed on the outside of the filter cartridge, and the filter element is arranged in the filter cartridge.

23. The filter device according to claim 22, wherein the filter cartridge comprises a cylindrical wall, and a plurality of flow holes are arranged through the cylindrical wall of the filter cartridge along a thickness direction.

24. The filter device according to claim 23, wherein the prompt assembly comprises two tympanic membranes, a fixing plate, a support member and a gland; the tympanic membranes are clamped between the cylinder wall of the filter cartridge and the fixing plate, and the tympanic membrane is correspondingly arranged at the flow hole; the support member is clamped between the fixing plate and the gland, and the support member has mounting cavities corresponding to the tympanic membrane one-to-one for mounting the first pressure sensor and the second pressure sensor.

25. The filter device according to claim 24, wherein one of the flow holes is arranged on a wall of an inlet fluid passageway of the filter cartridge, and the other flow hole is arranged on a wall of an outlet fluid passageway of the filter cartridge.

26. The filter device according to claim 25, wherein the prompt assembly is connected to the filter cartridge through a connecting pipe.

27. The filter device according to claim 26, wherein the prompt assembly comprises an upper fixing plate and a lower fixing plate; the tympanic membranes are clamped between the lower fixing plate and the upper fixing plate; the lower fixing plate is provided with a fluid passage connecting the connecting pipe and the tympanic membrane; the support member is clamped between the gland and the upper fixing plate and the first pressure sensor and the second pressure sensor are in one-to-one correspondence with the tympanic membrane and abut with the back of the tympanic membrane.

28. The filter device according to claim 21, wherein an output end of the controller is connected to a contamination alarm prompt module; when the difference of the first pressure sensor and the second pressure sensor reaches a set threshold, the controller outputs a control signal to control an action of the contamination alarm prompting module.

29. The filter device according to claim 28, wherein the action of the contamination alarm prompt module refers to one or more of sound prompt, light prompt, voice prompt, and mobile phone APP prompt.
